(19) United States
(12) Patent Application Publication
(10) Pub. No.: US 2006/0266162 A1
(43) Pub. Date: Nov. 30, 2006

(54) Fastening element guide device for a power drive-in tool

(75) Inventors: Marco Zurkirchen, Bubikon (CH); Marcel Koelliker, Kusnacht (CH); Sven Matthiesen, Lindau (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellscahft

(21) Appl. No.: 11/437,249

(22) Filed: May 19, 2006

(30) Foreign Application Priority Data
May 30, 2005 (DE) 10 2005 000 070.3

(51) Int. Cl. B25B 23/00; B25B 17/00

(52) U.S. Cl. 81/57.37; 81/451

(57) ABSTRACT

A fastening element guide device for a power drive-in tool includes a first unit (11) connectable with the drive-in tool (40), and a second unit (19) displaceably supported on the first unit (11) and having a head section (20) and two jaw elements (21, 22) arranged on opposite sides of a tool axis (A) for clamping a drive-in bit (13) therebetween and pivotal between a closed position (16) in which jaws (23) of the jaw elements (21, 22) are spaced from the tool axis (A) by a minimal distance, and an open position (17) in which the jaws (23) of the jaw elements (21, 22) are spaced from the tool axis (A) by a greater distance, with the jaw elements (21, 22) having actuation elements (24) which are acted upon by control elements (12) provided on the first unit (11) for pivoting the jaw elements (21, 22) from their closed position (16) to their open position (11).

### BACKGROUND OF THE INVENTION

1. Field of the Invention

The present invention relates to a fastening element guide device for a power drive-in tool and which includes a first unit connectable with the drive-in tool, and a second unit displaceably supported on the first unit and having a head section placeable against a constructional component and including two jaw elements arranged on opposite sides of a tool axis for clamping a drive-in bit therebetween and pivotal between a closed position in which jaws of the jaw elements are spaced from the tool axis by a minimal distance, and an open position which the jaws of the jaw elements are spaced from the tool axis by a greater distance.

2. Description of the Prior Art

A fastening element guide device for a power drive-in tool such as, e.g., screwdriving tool, includes a head section designed to be placed against a constructional component and serving for holding and guiding fastening elements such as, e.g., screws before and during a drive-in process. The head section can, e.g., be a part of a fastening element magazine or of a fastening element transporting device placeable or securable on a flange of a drive-in tool.

U.S. Patent Publication 2002/0108995 A1 discloses a screw guide device for a drive-in or screwdriving tool the first unit of which is secured on a flange of a screwdriving tool with a clamping ring. The second unit is telescopically arranged with respect to the first unit and is provided at its end facing in the operational direction of the drive-in tool with a nosepiece that has two opposite pivotal jaw elements for guiding the screw. In a closed position, i.e., when the free ends of the jaw elements are closed to each other, the jaw elements can guide a fastening element or a screw. During a screw-in process, two pins are lifted, respectively, from control shoulders of the jaw elements in order to enable the pivotal movement of the jaw elements away from each other and, thereby, opening of the jaw elements. The opening is effected during a further drive-in process, by displacement of the screw past inner surfaces of the jaw elements adjacent thereto.

The drawback of the known device consists in that the jaw elements, as a rule, are first completely open by the screw head which is wider than the screw stem. Thus, the forces necessary for a complete opening of the jaws depend on the diameter and the geometry of the screw head. Therefore, the opening behavior of the jaw elements would be different for different types of screws.

Accordingly, the object of the invention is to provide a fastening element guide device for a power drive-in tool with which a uniform opening behavior and a good guidance of the screws is achieved independent of the type of the to-be-driven-in screws.

### SUMMARY OF THE INVENTION

This and other objects of the present invention, which will become apparent hereinafter, are achieved by providing a fastening element guide device in which the jaw elements have actuation means provided thereon and the first unit includes control means acting on the actuation means of the jaw elements for pivoting the jaw elements from their closed position to their open position.

The present invention insures a uniform opening behavior of the jaw elements independent of the type of the fastening elements or the diameter of their heads. The opening of the jaw elements is carried out always with the same force. Also, an optimal guidance of the fastening element is insured.

Advantageously, the first unit is formed as a housing, and the inner surfaces of the housing form the control means. Thereby, in a technically simple way, there is available control means that does not require use of any additional components.

Advantageously, the actuation means is formed as projections extending from respective jaw elements in a direction away from the tool axis. Thereby, the projections can cooperate in a simple way with the control means of the first unit when the second unit is pushed into the first unit during a drive-in process.

It is further advantageous when the projections have, adjacent to the first unit, ramp- or dome-shaped flanks. Thereby, tilting or hooking and a need in large force expenditure during pivoting of jaws elements with control means, is prevented.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a plan view of a fastening element guide device for a drive-in power tool shown during a screw-in process;

FIG. 2 a plan view of the fastening element guide device shown in FIG. 1 during a further step of the screw-in process; and

FIG. 3 a bottom view of a portion of the fastening element guide device shown in FIG. 2.

### DETAILED DESCRIPTION OF THE PREFERRED EMBODIMENTS

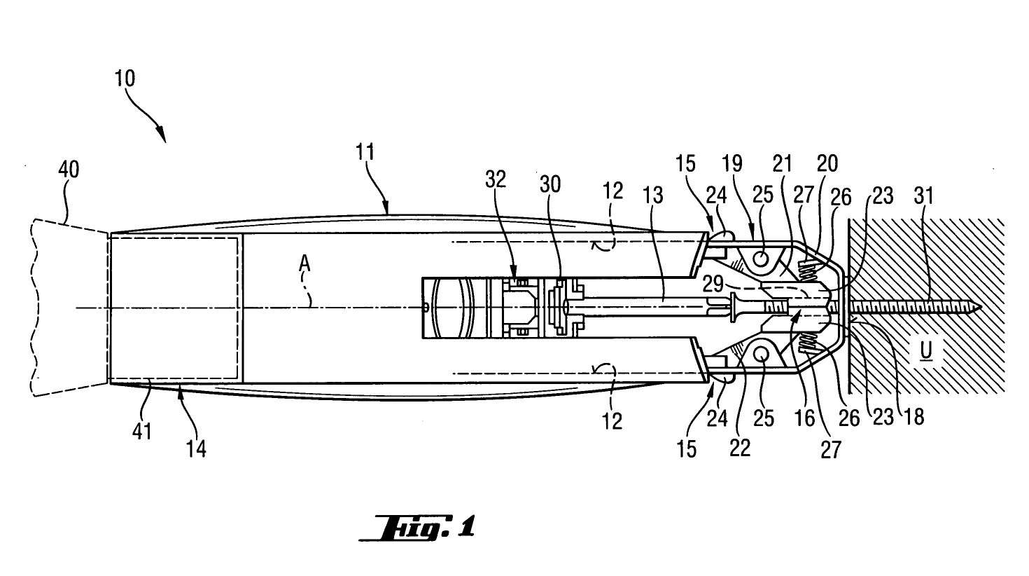

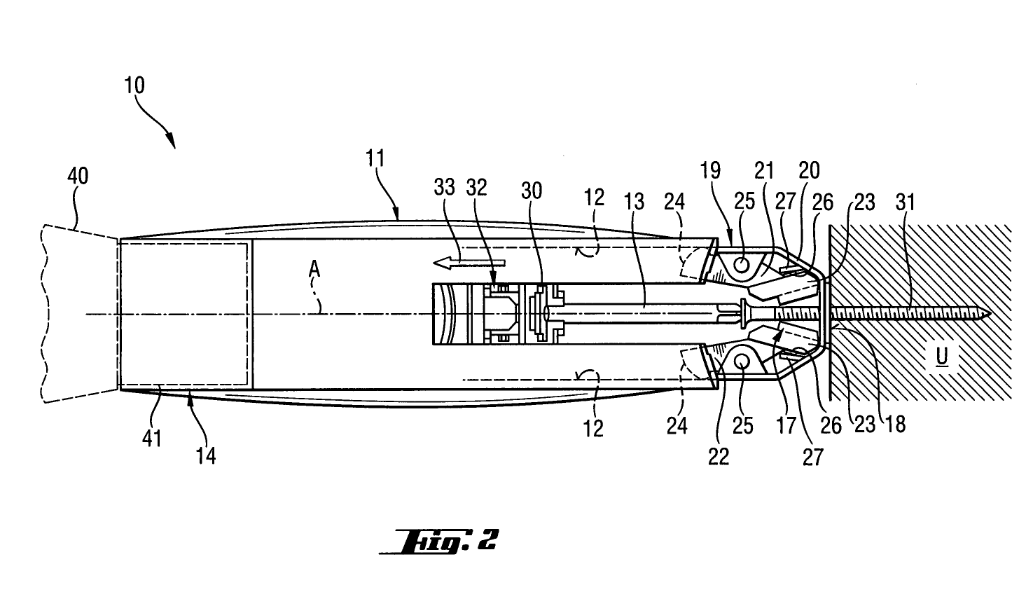

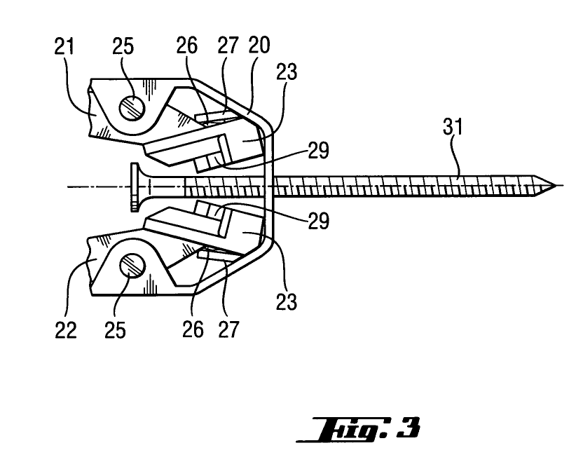

A fastening element guide device 10 according to the present invention, which is shown in FIGS. 1-3, is releasably connectable with a power drive-in tool 40, shown in the drawings only schematically, by a coupling section 14 securable to a flange 41 of the power tool 40. The schematically shown power drive-in tool 40 is formed as an electrical screw-driving tool. The fastening element guide device 10 is formed as a screw magazine with an integrated transporting mechanism 32 for displacement of a screw magazine strip 30. In the fastening element guide device 10, a drive-in bit 13, which is formed as a screwdriver and which is rotated by the power drive-in tool 40, is displaced linearly.

The fastening element guide device 10 has a first unit 11 that includes the coupling section 14 and is formed as a guide housing, and a second unit 19 displaceably supported on the first unit 11. The second unit 19 carries the transportation mechanism 32, and the screw magazine strip 30 is guided therein. The second unit 19 has a head section 20 that engages a constructional component U with its end surface 18. On the head section 20, sidewise of the axis A defined by the drive-in bit 13, there are arranged two jaw elements 21, 22. The jaw elements 21, 22 are pivotally supported on the head element 20 in pivot supports 25. The jaw elements 21, 22 have, at their ends adjacent to the end surface 18, jaws 23 which can hold and guide a fastening element 31, such as, e.g., a screw in a closed position 16 shown in FIG. 1. The jaws 23 of the jaw elements 21, 22 need not necessarily seamlessly abut each other but can, dependent on the thickness of the stem of the fastening element 31 they guide, be spaced from each other by a small distance. The jaws 23 have each, for guiding the fastening element 31, a portion of a guide channel 29 through which the fastening elements 31 is displaceable. The jaw elements 21, 22 are biased in a direction of the closed position 16 by springs 26 which are supported against the jaws 23, on one hand, and, on the other hand, are supported against projections 27 on the head section 20. At the ends of jaw elements 21, 22 remote from the end surface 18, there are provided actuation elements 24 formed as projection and extending from the jaw elements 21, 22 in a direction away from the axis A. The flanks 15 of the actuation elements 24, which are adjacent to the first unit 11, ascend in form of a ramp or dome.

In the first unit 11, control elements 12 are provided. The control elements 12 are formed by inner walls of the first unit 11. The actuation elements 24 are displaced relative to the control elements 12 with their flanks 15 engaging the control elements 12.

When the drive-in tool 40 is pressed with the fastening element guide device 10, which is mounted thereon, against the constructional component U, and the fastening element 31 is driven in the constructional component, the second unit 19 is displaced in the first unit 11 in the direction of arrow 33. During this movement, the actuation elements 24 on the jaw elements 21, 22 are displaced with their ramp- and dome-shaped ascending flanks 15 relative to the control elements 12 in the first unit 11 and are displaced, as a result in the direction of the axis A. Thereby, the jaw elements 21, 22 pivot from the closed position 16 to an open position 17 in which the jaws 23 release the fastening element 31. In the open position 17, the jaws 23 are spaced by a larger distance form the axis A than in the closed position 16. The jaws 23 move away from each other before the fastening element 31 is completely screwed in the constructional component U.

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A fastening element guide device for a power drive-in tool, comprising a first unit (11) connectable with the drive-in tool (40); and a second unit (19) displaceably supported on the first unit (11) and having a head section (20) placeable against a constructional component (U) and including two jaw elements (21, 22) arranged on opposite sides of a tool axis (A) for clamping a drive-in bit (13) therebetween and pivotal between a closed position (16) in which jaws (23) of the jaw elements (21, 22) are spaced from the tool axis (A) by a minimal distance, and an open position (17) in which the jaws (23) of the jaw elements (21, 22) are spaced from the tool axis (A) by a greater distance, the jaw elements (21, 22) having actuation means (24) provided thereon, the first unit (11) including control means (12) acting on the actuation means (24) of the jaw elements (21, 22) for pivoting the jaw elements (21, 22) from the closed position thereof (16) to the open position thereof (17).

2. A fastening element guide device according to claim 1, wherein the first unit (11) is formed as a housing, and inner surfaces of the housing form the control means (12).

3. A fastening element guide device according to claim 1, wherein the actuation means (24) is formed as projections extending from respective jaw elements in a direction away from the tool axis (A).

4. A fastening element guide device according to claim 3, wherein the projections have ramp- or dome-shaped flanks (15) located adjacent to the first unit (11).
